(19) United States
(12) Patent Application Publication
(10) Pub. No.: US 2019/0279601 A1
(43) Pub. Date: Sep. 12, 2019

(54) METHOD AND PROCESSOR FOR IMPROVING RENDERING OF GRAPHIC INTERFACE

(71) Applicant: MEDIATEK INC., Hsin-Chu City (TW)

(72) Inventors: Chiung-Fu CHEN, Hsinchu City (TW); Xiang XU, Beijing (CN)

(21) Appl. No.: 15/925,905

(22) Filed: Mar. 20, 2018

(30) Foreign Application Priority Data
Mar. 6, 2018 (CN) 201810182298.0

(51) Int. Cl. G09G 5/34; G06T 3/20

(52) U.S. Cl. CPC G09G 5/346; G06T 3/20; G06T 2200/28; G09G 2360/18; G09G 2340/0464

(57) ABSTRACT

The invention provides method and processor for improving rendering of a graphic interface. The method may comprise: in response to a panning request in a region of the graphic interface, obtaining an offset vector; and, in response to an address for accessing an address of a buffer for the region, performing an address translation by translating the address to a translated address according to the offset vector.

This application claims the benefit of People's Republic of China application Serial No. 201810182298.0, filed Mar. 6, 2018, the subject matter of which is incorporated herein by reference.

### FIELD OF THE INVENTION

The present invention relates to method and processor for improving rendering of graphic interface, and more particularly, to method and processor improving rendering of panning by: translating requested addresses according to offset of panning, and accessing the translated addresses instead of the requested addresses, wherein the requested addresses are addresses of a buffer requested to access by a producer and/or a consumer of a graphic interface for graphic content.

### BACKGROUND OF THE INVENTION

Modern electronic devices, such as mobile phones, smart phones, digital cameras, camcorders, portable/handheld/tablet/notebook computers, game consoles, navigators, and/or wearable gadgets, etc., have broadly adopt graphic interface to, for example, display texts, documents, images, drawings, photos, web pages and/or videos, etc.

On graphic interface, panning is one of the most frequently activities. Panning may include, for example, vertically scrolling a list of items, a record of chatting or a web page up and/or down, horizontally sliding a panoramic photo left and/or right, and moving to view different portions of an image along an oblique direction combining vertical and horizontal directions.

### SUMMARY OF THE INVENTION

An objective of the invention is providing a method (e.g., 200 in FIG. 2) for improving rendering of a graphic interface. The method may comprise: (e.g., 202) in response to a panning request in at least a region (e.g., R) of the graphic interface, obtaining an offset vector (e.g., (x, y)); and, (e.g., 204) in response to an address for accessing a buffer (e.g., 110 in FIG. 1) for the region, performing an address translation by translating the address to a translated address according to the offset vector.

In an embodiment, the offset vector may be provided by a producer (e.g., 102 in FIG. 1) of the graphic interface according to the panning request.

In an embodiment, the address translation may be performed when a producer (e.g., 102 in FIG. 1) of the graphic interface requests to write an address of the buffer. In an embodiment, the address translation may be performed when a consumer (e.g., 104 in FIG. 1) of the graphic interface requests to read an address of the buffer.

In an embodiment (e.g., FIG. 3b or 4b), wherein the panning request causes the region to change from a first content (e.g., c1 or C1 in FIG. 3b or 4b) to a second content (e.g., c2 or C2 in FIG. 3b or 4b), and the address translation may be arranged to enable an address (e.g., a0) for a second pixel of the second content to be translated to an address (e.g., a2) storing a first pixel of the first content; and, a position (e.g., pa1 or pb1 in FIG. 3b or 4b) of the first pixel may be separated from a position (e.g., pTL) of the second pixel by an opposite vector of the offset vector (e.g., (0, y2) or (x2, y2) in FIG. 3b or 4b).

In an embodiment (e.g., FIG. 3b or 4b), the panning request causes the region to change from a first content (e.g., c1 or C1 in FIG. 3b or 4b) to a second content (e.g., c1 or C1 in FIG. 3b or 4b), and the address translation may be arranged to enable an address (e.g., a0) for a pixel (e.g., pixel at position pTL) of the first content and an address (e.g., a0) for the same pixel of the second content to be respectively translated to two different addresses (e.g., a2).

In an embodiment (e.g., FIG. 3b), the panning request (e.g., (0, y2)) is along a direction aligning a boundary of the region (e.g., a vertical upward direction), and causes the region to change from a first content (e.g., c1) to a second content (e.g., c2); the address translation causes an address for a corner pixel (e.g., pixel at position pTL) of the first content to be translated to a first address (e.g., a1), and causes an address for said corner pixel of the second content to be translated to a second address (e.g., a2); and the method further may comprise: within addresses of the buffer allocated for the region, updating the buffer at addresses extending from the first address until the second address along an opposite (e.g., vertical downward direction) of the direction, and extending across along a second direction (e.g., vertical direction) perpendicular to the direction (e.g., updating at addresses originally storing text “item C” of buffer content B1 to replace with text “item L”); and remaining unchanged at a number of the rest of the addresses allocated for the region (e.g. remaining unchanged at addresses storing texts “item D” to “item I”).

In an embodiment (e.g., FIG. 4b), the panning request (e.g., (x2, y2)) is along a combination of a horizontal direction and a vertical direction, and causes the region to change from a first content (e.g., C1) to a second content (e.g., C2); the address translation causes an address (e.g., a0) for a corner pixel (e.g., pixel at position pTL) of the first content to be translated to a first address (e.g., a1), and causes an address for said corner pixel of the second content to be translated to a second address (e.g., a2); and the method may further comprise: within addresses of the buffer allocated for the region, updating the buffer at addresses extending from the first address until the second address along an opposite of the vertical direction and horizontally extending across (e.g., updating at addresses originally storing texts “37” to “36” of buffer content Bb1 to replace with texts “B7” to “B6”); and, updating the buffer at addresses extending from the first address until the second address along an opposite of the horizontal direction and vertically extending across (e.g., updating at addresses originally storing texts “92” to “83” to replace with texts “98” to “89”); and remaining the content of the buffer unchanged at a number of the rest of the addresses allocated for the region (e.g. remaining unchanged at addresses storing texts “44” to “86”).

In an embodiment, the address translation may be performed by a hardware address translator (e.g., 100 in FIG. 1). In an embodiment, the offset vector is obtained via an API (application programming interface, e.g., 112 in FIG. 1) which is called by a producer (e.g., 102) of the graphic interface.

In an embodiment (e.g., FIG. 3b), the panning request (e.g., (0, y2)) causes the region to change from a first content (e.g., c1) to a second content (e.g., c2), the first content includes a first portion (e.g., text “item C”) not included in the second content, and the second content includes a second portion (e.g., text “item L”) not included in the first content, and the address translation may be arranged to enable addresses for the second portion to be translated to addresses storing the first portion.

An objective of the invention is providing a processor (e.g., 120 in FIG. 1). The processor may comprise: an access circuit (e.g., 106) for accessing a buffer (e.g., 110), and an address translator (e.g., 100) coupled to the access circuit, for: in response to a panning request in a region of the graphic interface, obtaining an offset vector; and, in response to an address of the buffer for the region, performing an address translation by translating the address to a translated address according to the offset vector, and then enabling the access circuit to access the translated address of the buffer instead.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates an electronic device according to an embodiment of the invention;

FIG. 2 illustrates a flowchart according to an embodiment of the invention;

FIG. 3a (prior art) illustrates graphic contents of panning and associated buffer contents expected by the producer and the consumer shown in FIG. 1;

FIG. 3b illustrates physical buffer contents under address translation of the invention for rendering the panning in FIG. 3a; and

FIG. 4a (prior art) illustrates graphic contents of panning and associated buffer contents expected by the producer and the consumer shown in FIG. 1;

FIG. 4b illustrates physical buffer contents under address translation of the invention for rendering the panning in FIG. 4a.

### DETAILED DESCRIPTION OF PREFERRED EMBODIMENTS

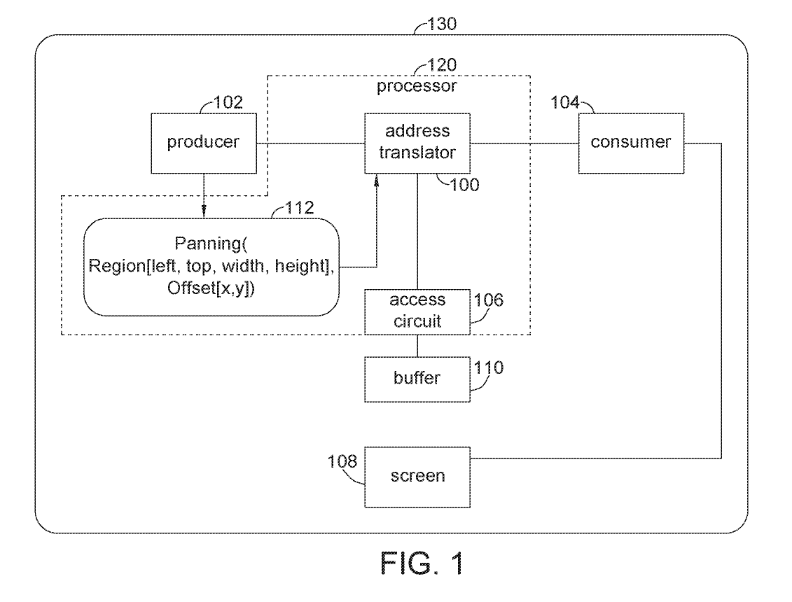

Please refer to FIG. 1 illustrating an electronic device 130 according to an embodiment of the invention. The electronic device 130 may be a mobile phone, a smart phone, a digital camera, a camcorder, a portable/handheld/tablet/notebook computer, a game console, a navigator or a wearable gadget, etc. The electronic device 130 may include a processor 120, a buffer 110 and a screen 108. The processor 120 may include an address translator 100 and an access circuit 106 coupled to the buffer 110. The address translator 100 may be coupled between a producer 102 of graphic interface, a consumer 104 of graphic interface, and the access circuit 106. The access circuit 106 may access (e.g., read and write) the buffer 110 according to addresses provided by the address translator 100.

The producer 102 may be a hardware GPU (graphic processing unit), CPU (central processing unit) or logic circuitry executing graphic processing software and/or firmware. The producer 102 may render (e.g., calculate, generate, and/or update) graphic contents (e.g., frames), and may request to access addresses of the buffer 110 to write the graphic contents to the buffer 110.

On the other hand, the consumer 104 may request to access addresses of the buffer 110 to read graphic contents from the buffer 110. In an embodiment, the consumer 104 may be a display controller (embedded in the processor 120 or external to the processor 120) coupled to a screen 108, and may control the screen 108 to display the graphic contents read from the buffer 110. In an embodiment, the consumer 104 may be a graphic encoder and/or decoder for encoding and/or decoding the graphic contents read from the buffer 110. In an embodiment, the consumer 104 may be an interface circuit to a nonvolatile memory for transmitting the graphic contents read from the buffer 110 to the nonvolatile memory.

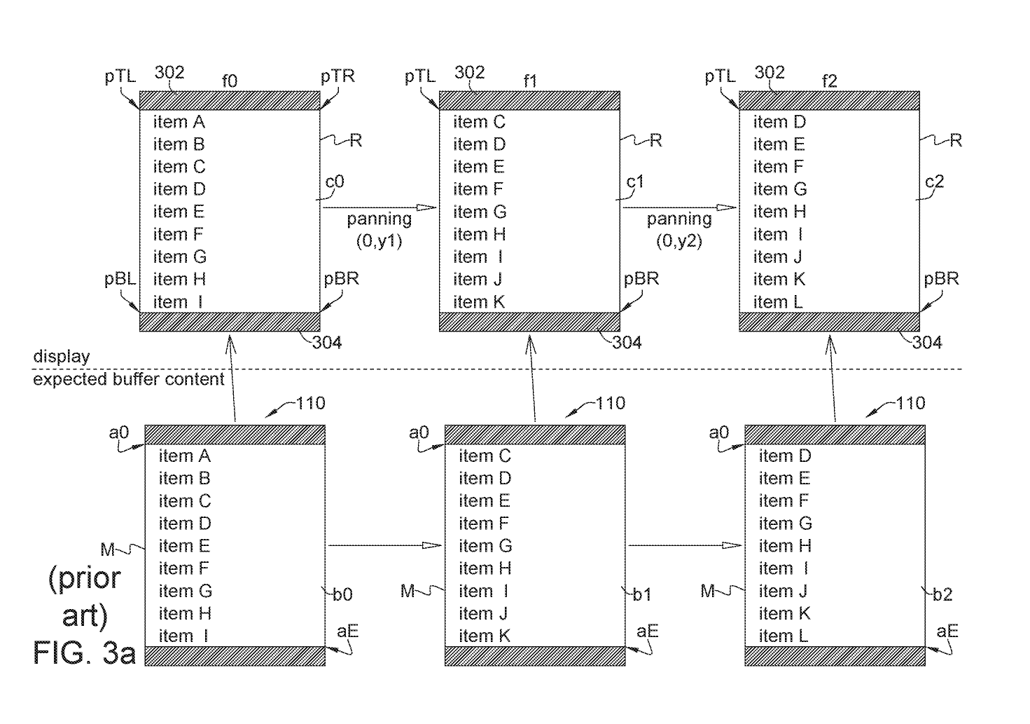

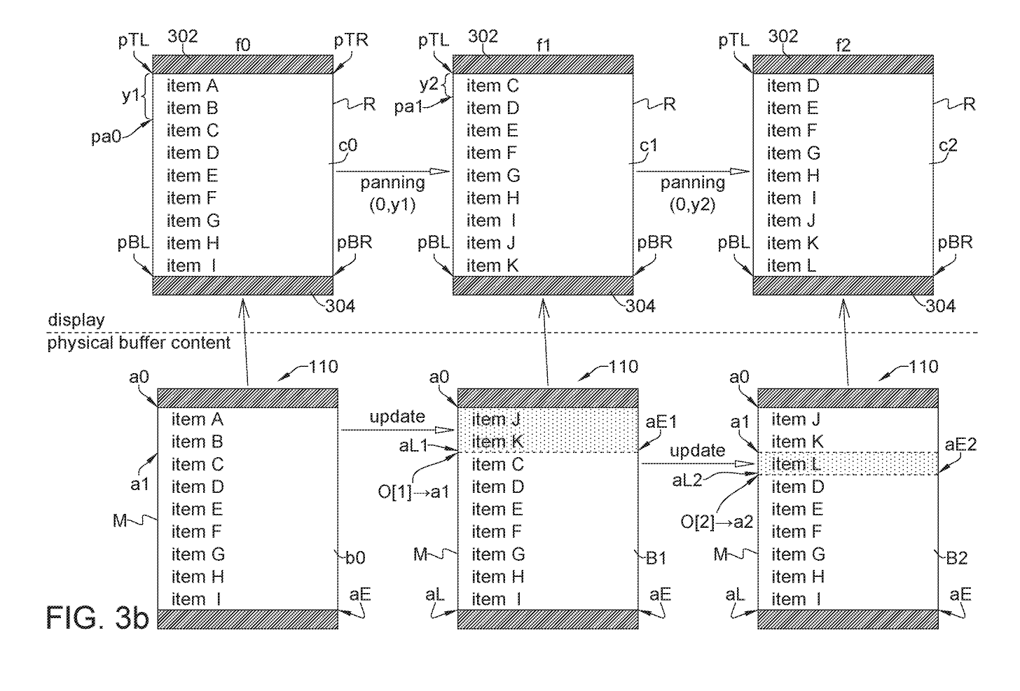

For example, operations of the producer 102 and the consumer 104 may be understood by referring to FIG. 3a (prior art) which illustrates a scenario wherein a first vertical panning with an offset vector (0, y1) and a second vertical panning with an offset vector (0, y2) respectively cause graphic interface to change from a frame f0 to a frame f1, and to change from the frame f1 to a frame f2, so a vertical lists of entries (e.g., texts “item A” and “item B”) shown in a graphic region R (between a head bar 302 and a tail bar 304, with four corner pixels at positions pTL, pBL, pTR and pBR) of each frame is scrolled up by sequentially changing from a content c0 (revealing texts “item A” to “item I”) of the frame f0 to a content c1 (revealing texts “item C” to “item K”) of the frame f1 and a content c2 (revealing texts “item D” to “item L”) of the frame f2. In the buffer 110, a buffer region M extending from an address a0 to an address aE may be allocated for the content of the graphic region R.

Both the producer 102 and the consumer 104 may be arranged to expect that the addresses a0 and aE of the buffer region M are respectively for the corner pixels at the positions pTL and pBR of the graphic region R, and may therefore expect that a buffer content from the addresses a0 to aE reflects a graphic content of the pixels at the positions extending from pTL to pBR.

For example, to display the content c0, the consumer 104 may request to read the addresses a0 to aE of a buffer content b0 rightwards and downwards for the pixels at the positions pTL to pBR of the graphic content c0.

During transition from the frame f0 with the content c0 to the frame f1 with the content c1, based on an expectation that the addresses a0 to aE of the buffer region M may reflect the pixels at the positions pTL to pBR of the content c1, the producer 102 may expect a buffer content b1 to be formed in the buffer region M. Then, based on the same expectation, the consumer 104 may request to read the addresses a0 to aE of the buffer 110 to display the content c1 from the positions pTL to pBR rightwards and downwards.

Similarly, during transition from the frame f1 with the content c1 to the frame f2 with the content c2, the producer 102 may expect a buffer content b2 to be formed in the buffer region M based on an expectation that the addresses a0 to aE of the buffer content b2 may reflect the pixels at positions pTL to pBR of the content c2. Then, based on the same expectation, the consumer 104 may request to read the addresses a0 to aE to display the content c2 from the positions pTL to pBR.

In other words, independent of direction and magnitude of panning, both the producer 102 and the consumer 104 may be arranged to request the address a0 for the top-left corner pixel at the position pTL, and request the address aE for the bottom-right corner pixel at the position pBR. Under such fixed address-pixel mapping, both the producer 102 and the consumer 104 may expect the buffer contents b0, b1 and b2 from the addresses a0 to aE to exactly equal the graphic contents c0, c1 and c2 from the positions pTL to pBR. However, such fixed address-pixel mapping may cause significant waste of resources (power, time, bus bandwidth, etc.), since buffer content of the buffer region M needs to be fully updated from the content b0 to the contents b1 and b2. For example, to transit from the frames f0 to f1, addresses storing the texts “item C” to “item I” of the buffer content b0 needs to be updated to the texts “item E” to “item K” when forming the buffer content b1, even though the buffer content b1 also includes the texts “item C” to “item I”. Similarly, to transit from the frames f1 to f2, addresses storing the texts “item D” to “item K” of the buffer content b1 needs to be updated to the texts “item E” to “item L” when forming the buffer content b2, even though the buffer content b2 also includes the texts “item D” to “item K”.

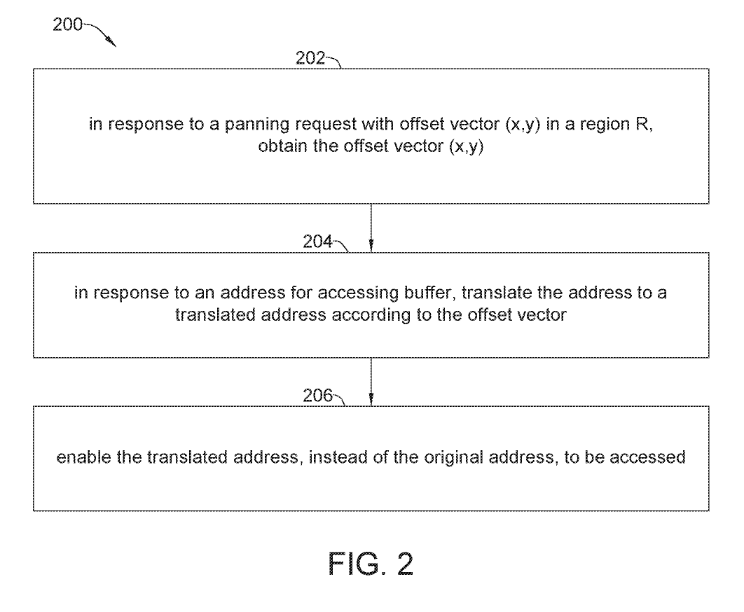

Along with FIG. 1, please refer to FIG. 2 illustrating a flowchart 200 according to an embodiment of the invention. To overcome aforementioned issues, when panning with a panning offset vector (x, y) occurs in a region R of graphic interface and causes the region R changes from a content c[i−1] of a frame f[i−1] to a content c[i] of a consecutive frame f[i] (not shown), the processor 120 may adopt the flowchart 200 in FIG. 2 to improve rendering of panning (e.g., rendering of the content c[i]) by operations of the address translator 100. As shown in FIG. 2, major steps and cooperation of the producer 102, the consumer 104, the access circuit 106 and the address translator 110 may be described as follows.

Step 202: in response to the panning offset vector (x, y) in the region R, the producer 102 may provide a value Offset[x, y] to reflect the offset vector (x, y) and an value Region[left, top, width, height] to reflect position and range of the region R, and may call an API 112 (FIG. 1) with the values Offset[x, y] and Region[left, top, width, height] as two input arguments. Via the API 112, the address translator 100 may obtain the offset vector (x, y) and the region R. In some embodiments, the address translator 100 may obtain the offset vector (x, y) and the region R by other ways, such as directly from the producer 102.

Step 204: when the producer 102 and/or the consumer 104 requests to access an address of the buffer 110, in response to the address, the address translator 100 may perform an address translation by translating the requested address to a translated address according to the offset vector (x, y) obtained in step 202.

Step 206: the address translator 100 may send the translated address, rather than the originally requested address, to the access circuit 106, and therefore enable the access circuit 106 to access the translated address of the buffer 110, instead of the requested address.

For example, when the producer 102 requests to write a pixel value (which may include multiple color components) to a requested address, the address translator 100 may translate the requested address to a translated address in step 204; and, in step 206, enable the access circuit 106 to write the pixel value to the translated address, instead of the requested address. Similarly, when the consumer 104 requests to read data (e.g. pixel value) from a requested address, the address translator 100 may translate the requested address to a translated address in step 204; and, in step 206, enable the access circuit 106 to read and return a pixel value stored at the translated address, instead of a pixel value stored at the requested address.

Continuing the example shown in FIG. 3a, please refer to FIG. 3b illustrating physical buffer access under address translation of the flowchart 200. In FIGS. 3a and 3b, the first panning with the offset vector (0, y1) causes the region R to change from the content c0 to the content c1. To render the content c1 by the flowchart 200, as shown in FIG. 3b, the address translation in step 204 may be arranged to enable the address O[1]=a0 for the pixel at the position pTL of the content c1 to be translated to an address a1 storing a pixel at a position pa0 of the content c0, wherein the geometric position pa0 is separated from the geometric position pTL by an opposite vector (0, −y1) of the offset vector (0, y1) obtained in step 202. In other words, the address translation performed in step 204 may translate a requested address to a translated address by summing a translation value and the requested address, wherein the translation value may reflect a difference between the addresses a1 and a0. If a sum of the requested address and the translation value exceeds a bottom or top bound of the buffer region M by a vertical exceeding value, the resultant translated address may cycle back from the opposite (top or bottom) bound by the vertical exceeding value; similarly, if the sum of the requested address and the translation value exceeds a right or left bound of the buffer region M by a horizontal exceeding value, the resultant translated address may cycle back from the opposite (left or right) bound by the vertical exceeding value. For example, as shown in FIG. 3b, when the producer 102 or the consumer 104 requests an address aL and the address aE of the buffer region M for the corner pixels at the positions pBL and pBR of the content c1, the address translator 100 may translate the address aL to an address aL1 cycling back from the top bound to be above the address a1, and translate the address aE to an address aE1.

As explained in FIG. 3a, during transition from contents c0 to c1, the producer 102 may operate based on the expectation that content of the buffer region M from the addresses a0 to aE may reflect the content c1 from the positions pTL to pBR. Because the address translator 100 may translate the addresses a0 to aE to the addresses a1 to aE1 (step 204), operations of the producer 102 may actually form the buffer content B1 (step 206) as shown in FIG. 3b, instead of the expected buffer content b1 shown in FIG. 3a. From the address a1 (translated from the address a0) downwards and cycling from the top bound to the address aE1 (translated from the address aE), the buffer content B1 may store the texts “item C” to “item I” and “item J” to “item K”, and may actually reflect the content c1 which demonstrates the texts “item C” to “item K” from the positions pTL to pBR. Hence, when the consumer 104 requests the addresses a0 to aE for the pixels at the positions pTL to pBR of the content c1, the address translator 100 may translate the addresses a0 to aE to the addresses a1 to aE1 (step 204), and enable the access circuit 106 to read the addresses a1 to aE1 of the buffer content B1 (step 206) to correctly display the graphic content c1.

When forming the buffer content 61 from the buffer content b0 (step 206), because of the address translation (step 204), the producer 102 may not need to update at the addresses storing the texts “item C” to “item I”, and may therefore significantly reduce resource waste. As shown in FIG. 3b, cooperation of the address translator 100 and the producer 102 may form the buffer content B1 (step 206) by updating a small portion (shown dotted in the buffer content B1) of the buffer region M at addresses vertically extending from the address a0 downwards until the address a1 and horizontally extending across the buffer region M, so as to replace the original texts “item A” and “item B” of the buffer content b0 with the texts “item J” and “item K”.

In the example of FIGS. 3a and 3b, the second panning with the offset vector (0, y2) causes the region R to change from the content c1 to the content c2. To render the content c2 by the flowchart 200, as shown in FIG. 3b, the address translation in step 204 may be arranged to enable the address O[2]=a0 for the pixel at the position pTL of the content c2 to be translated to an address a2 storing a pixel at a position pa1 of the content c1, wherein the position pa1 is shifted from the position pa0 by an opposite vector (0, −y2) of the offset vector (0, y2) obtained in step 202. In other words, the address translation performed in step 204 may translate a requested address to a translated address by summing the requested address and a translation value which may reflect magnitude and direction of the offset vector. For example, as shown in FIG. 3b, when the producer 102 or the consumer 104 requests the addresses aL and aE for the corner pixels at the positions pBL and pBR of the content c2, the address translator 100 may translate the address aL to an address aL2 cycling back from the top bound to be above the address a2, and translate the address aE to an address aE2.

Because the address translator 100 may translate the addresses a0 to aE to the addresses a2 to aE2 (step 204), operations of the producer 102 actually form the buffer content B2 shown in FIG. 3b (step 206), instead of the expected buffer content b2 shown in FIG. 3a. Cooperation of the address translator 100 and the producer 102 may form the buffer content B2 from the buffer content B1 (step 206) by updating a small portion (shown dotted in the buffer content B2, FIG. 3b) of the buffer region M at addresses vertically extending from the address a1 downwards until the address a2 and horizontally extending across the buffer region M, so as to replace the original text “item C” with the texts “item L”; on the other hand, the address translator 100 may enable the producer 102 to remain unchanged at the rest addresses, i.e., remain unchanged at the addresses storing the texts “item D” to “item I” and “item J” to “item K”. Then, the consumer 104 may request the addresses a0 to aE for the pixels at the positions pTL to pBR of the content c2, the address translator 100 may translate the addresses a0 to aE to the addresses a2 to aE2 (step 204), and enable the access circuit 106 to read the addresses a2 to aE2 of the buffer content B2 (step 206) to correctly display the graphic content c2, because the buffer content B2 stores the texts “item D” to “item I” and “item J” to “item L” from the address a2 (translated from the address a0) downwards and cycling to the address aE2 (translated from the address aE) to actually reflect the content c2 which demonstrates the texts “item D” to “item L” from the positions pTL to pBR.

From the example shown in FIGS. 3a and 3b, it is noted that the address translation performed by the address translator may be arranged to enable an address (e.g., a0) for a pixel (e.g., the pixel at the position pTL) of the first content (e.g., c1) and an address (e.g., a0) for the same pixel of the second content (e.g., c2) to be respectively translated to two different addresses (e.g., a1 and a2).

It is also noted that, in response to a panning along a direction aligning a boundary of the region M (e.g., the second panning along a vertical upward direction) causing the graphic region R to change from a first content (e.g., c1) to a second content (e.g., c2), if the address translator 100 causes an address (e.g., a0) for a corner pixel (e.g., the pixel at the position pTL) of the first content to be translated to a first address (e.g., a1) and causes an address for said corner pixel of the second content to be translated to a second address (e.g., a2), then the address translator 100 may enable a content (e.g., B2) of the buffer region M to be formed by: updating the buffer 110 at addresses extending from the first address until the second address along an opposite of the direction (e.g., extending from the addresses a1 until a2 along a vertical downward direction) and extending across along a second direction perpendicular to the direction (e.g., extending across the buffer region M along a horizontal direction perpendicular to the vertical direction), and by remaining unchanged at rest of the addresses allocated for the graphic region R.

In addition, it is noted that, as the panning (e.g., the second panning with the offset vector (0, y2)) causes the region R to change from a first content (e.g., c1) to a second content (e.g., c2), the first content may include a first portion (e.g., the text “item C”) not included in the second content, the second content may include a second portion (e.g., the text “item L”) not included in the first content, and the address translation in step 204 may be arranged to enable addresses for the second portion to be translated to addresses storing the first portion (e.g., enable the addresses for the text “item L” to be translated to the addresses originally storing the text “item C” in the buffer content B1), so as to minimize effort for updating the buffer region M, since rest addresses other than the addresses storing the first portion may remain unchanged.

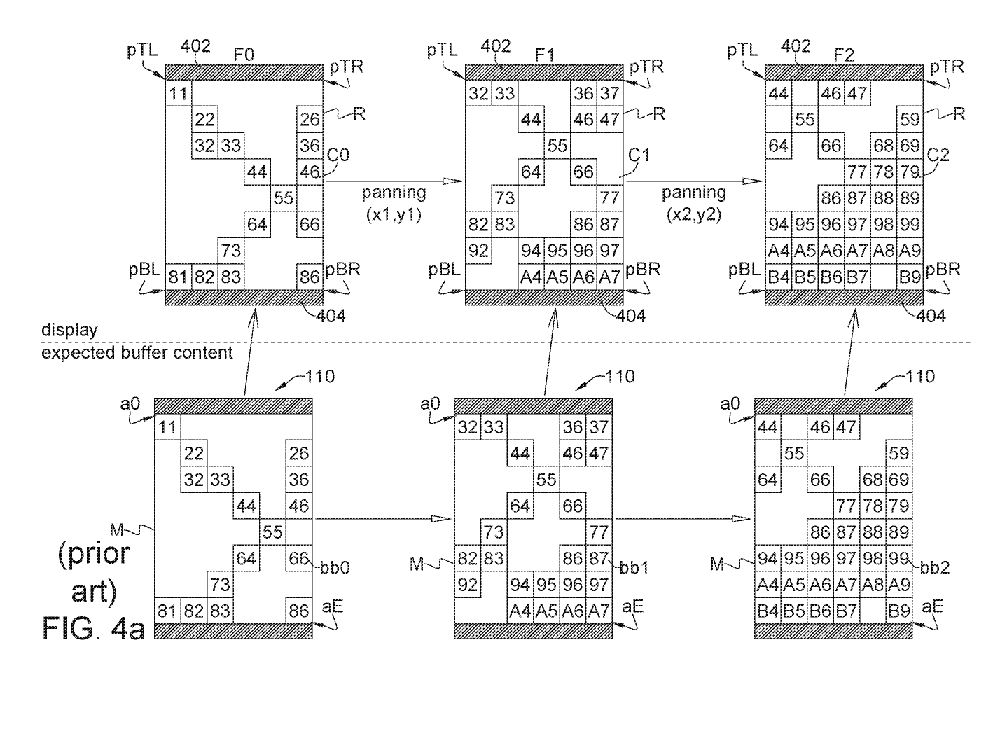

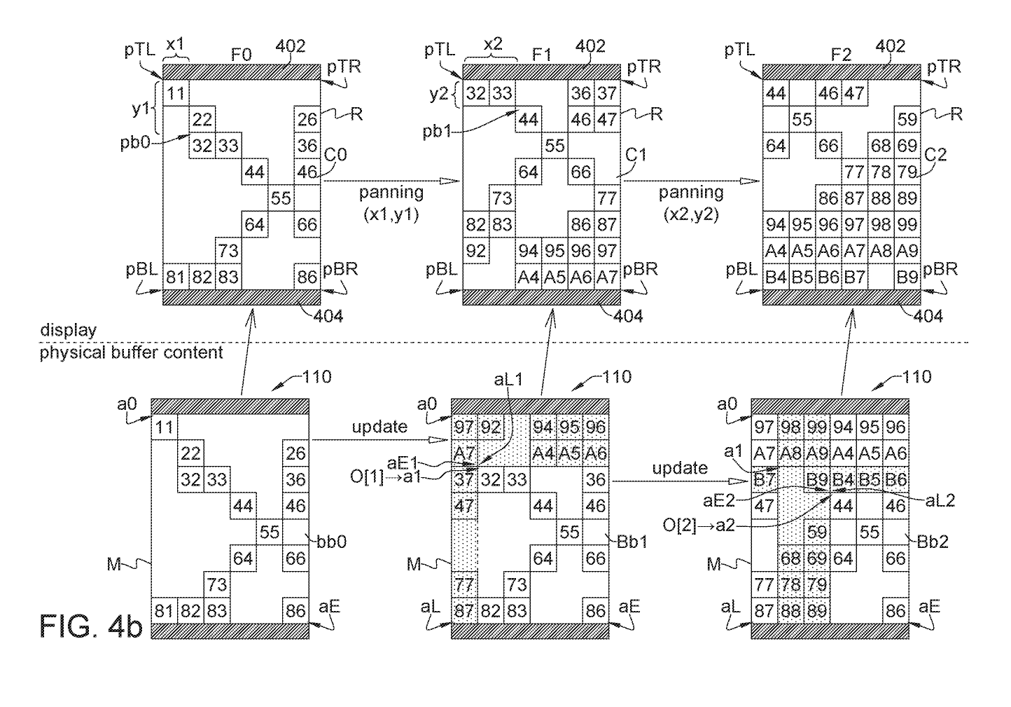

As another example, FIGS. 4a (prior art) and 4b illustrate a scenario wherein a first panning with an offset vector (x1, y1) and a second panning with an offset vector (x2, y2) respectively cause graphic interface to change from a frame F0 to a frame F1, and to change from the frame F1 to a frame F2, so a plurality boxed texts (such as boxed texts “11” and “86”) shown in a graphic region R (between a head bar 402 and a tail bar 404, with four corner pixels at positions pTL, pBL, pTR and pBR) of each frame is moved by sequentially changes from a content C0 of the frame F0 to a content C1 of the frame F1 and a content C2 of the frame F2. In the buffer 110, a buffer region M extending from an address a0 to an address aE may be allocated for the content of the graphic region R.

Both the producer 102 and the consumer 104 may be arranged to expect that a content of the buffer region M from the addresses a0 to aE reflects a graphic content from the positions pTL to pBR. For example, to display the content C0, the consumer 104 may request to read the addresses a0 to aE of a buffer content bb0 rightwards and downwards for the pixels at the positions pTL to pBR of the graphic content C0.

During transition from the frame F0 with the content C0 to the frame F1 with the content C1, the producer 102 may expect a buffer content bb1 to be formed in the buffer region M based on an expectation that the addresses a0 to aE of the buffer content bb1 may reflect the pixels at the positions pTL to pBR of the content C1. Then, based on the same expectation, the consumer 104 may request to read the addresses a0 to aE of the buffer 110 to display the content C1 from the positions pTL to pBR.

During transition from the frame F1 with the content C1 to the frame F2 with the content C2, the producer 102 may expect a buffer content bb2 to be formed in the buffer region M based on an expectation that the addresses a0 to aE of the buffer content bb2 may reflect the pixels at the positions pTL to pBR of the content C2. Then, based on the same expectation, the consumer 104 may request to read the addresses a0 to aE to display the content C2 from the positions pTL to pBR.

In the example of FIGS. 4a and 4b, the first panning with the offset vector (x1, y1) causes the region R to change from the content C0 to the content C1. To render the content C1 by the flowchart 200, as shown in FIG. 4b, the address translation in step 204 may be arranged to enable the address O[1]=a0 for the pixel at the position pTL of the content C1 to be translated to an address a1 storing a pixel at a position pb0 of the content C0, wherein the position pb0 is separated from the position pTL by an opposite vector (−x1, −y1) of the offset vector (x1, y1) obtained in step 202. In other words, the address translation performed in step 204 may translate a requested address to a translated address by summing the requested address and a translation value which may reflect a difference between the addresses a1 and a0. For example, as shown in FIG. 4b, when the producer 102 or the consumer 104 requests the addresses aL and aE for the corner pixels at the positions pBL and pBR of the content C1, the address translator 100 may translate the address aL to an address aL1 cycling back from top bound of the buffer region M to be above the address a1, and translate the address aE to the address aE1 cycling back from top bound of the buffer region M to be above the address a1, and cycling back from right bound of the buffer region M to be left to the address aL1.

Because the address translator 100 may translate the addresses a0 to aE to the addresses a1 to aE1 (step 204), operations of the producer 102 actually form the buffer content Bb1 shown in FIG. 4b (step 206), instead of the expected buffer content bb1 shown in FIG. 4a. Joint operations of the address translator 100 and the producer 102 may form the buffer content Bb1 from the buffer content bb0 (step 206) by updating at a small portion (shown dotted in the buffer content Bb1, FIG. 4b) of the buffer region M, the portion may include addresses vertically extending from the address a0 downwards until the address a1 and horizontally extending across the buffer region M (i.e., addresses originally storing the boxed texts “11” to “26” of the content), as well as addresses horizontally extending from the address a0 rightwards until the address a1 and vertically extending across the buffer region M (i.e., addresses originally storing the boxed texts “11” to “81” of the content bb0). Thus, the boxed texts “11”, “81” and “26”, etc. of the content bb0 may be replaced with the boxed texts “97”, “87” and “A6”, etc. On the other hand, the address translator 100 may enable the producer 102 to remain unchanged at rest addresses, i.e., remain unchanged at the addresses for the boxed texts “32” to “86”. Then, the consumer 104 may request the addresses a0 to aE for the pixels at the positions pTL to pBR of the content C1, the address translator 100 may translate the addresses a0 to aE to the addresses a1 to aE1 (step 204), and enable the access circuit 106 to read the addresses a1 to aE1 of the buffer content Bb1 (step 206) to correctly display the graphic content C1, because the buffer content Bb1 stores the boxed texts “32” to “A7” from the address a1 (translated from the address a0) downwards and rightwards and cycling to the address aE1 (translated from the address aE) to actually reflect the content C1 which demonstrates the boxed texts “32” to “A7” from the positions pTL to pBR.

In the example of FIGS. 4a and 4b, the second panning with the offset vector (x2, y2) causes the region R to change from the content C1 to the content C2. To render the content C2 by the flowchart 200, as shown in FIG. 4b, the address translation in step 204 may be arranged to enable the address O[2]=a0 for the pixel at the position pTL of the content C2 to be translated to an address a2 storing a pixel at a position pb1 of the content C1, wherein the position pb1 is shifted from the position pTL by an opposite vector (−x2, −y2) of the offset vector (x2, y2) obtained in step 202. In other words, the address translation performed in step 204 may translate a requested address to a translated address by summing the requested address and a translation value which may reflect a difference between the addresses a2 and a0. For example, as shown in FIG. 4b, when the producer 102 or the consumer 104 requests the address aL and aE for the corner pixels at the positions pBL and pBR of the content C2, the address translator 100 may translate the address aL to an address aL2 cycling back from top bound of the buffer region M to be above the address a2, and translate the address aE to an address aE2 which cycles back from top bound of the buffer region M to be above the address a2, and cycles back from right bound of the buffer region M to be left to the address aL2.

Because the address translator 100 may translate the addresses a0 to aE to the addresses a2 to aE2 (step 204), operations of the producer 102 may actually form the buffer content Bb2 shown in FIG. 4b (step 206), instead of the expected buffer content bb2 shown in FIG. 4a. Joint operations of the address translator 100 and the producer 102 may form the buffer content Bb2 from the buffer content Bb1 (step 206) by updating a small portion (shown dotted in the buffer content Bb2, FIG. 4b) of the buffer region M, wherein the portion may include addresses vertically extending from the address a1 downwards until the address a2 and horizontally extending across the buffer region M (i.e., addresses originally storing the boxed texts “37” to “36” of the content Bb1), as well as addresses horizontally extending from the address a1 rightwards until the address a2 and vertically extending across the buffer region M (i.e., addresses originally storing the boxed texts “92” to “83” of the content Bb1). Thus, the boxed texts “37” to “36” and “92” to “83” of the content Bb1 may be replaced with the boxed texts “B7” to “B6” and “98” to “89”, etc. On the other hand, the address translator 100 may enable the producer 102 to remain unchanged at rest addresses, i.e., remain unchanged at the addresses storing the boxed texts “44” to “86”, “97” to “A7”, “94” to “A6” and “47” to “87”.

From the example shown in FIGS. 4a and 4b, it is noted that the address translation performed by the address translator 100 may be arranged to enable an address (e.g., a0) for a pixel (e.g., the pixel at the position pTL) of the first content (e.g., C1) and an address (e.g., a0) for the same corner pixel of the second content (e.g., C2) to be respectively translated to two different addresses (e.g., a1 and a2).

It is also noted that, in response to a panning along a combing of a horizontal direction (e.g., leftward direction) and a vertical direction (e.g., upward direction) causing the graphic region R to change from a first content (e.g., C1) to a second content (e.g., C2), if the address translator 100 causes an address (e.g., a0) for a corner pixel (e.g., the pixel at the position pTL) of the first content to be translated to a first address (e.g., a1) and causes an address for said corner pixel of the second content to be translated to a second address (e.g., a2), then the address translator 100 may enable a content (e.g., Bb2) of the buffer region M to be formed by: updating at addresses extending from the first address until the second address along an opposite (e.g., downward) of the vertical direction and horizontally extending across the buffer region M (e.g., be updated at addresses originally storing boxed texts “37” to “36” of the content Bb1 to the boxed texts “B7” to “B6”); and, updating at addresses extending from the first address until the second address along an opposite (e.g., rightward) of the horizontal direction and vertically extending across the buffer region M (e.g., be updated at addresses originally storing the boxed texts “92” to “83” of the content Bb1 to the boxed texts “98” to “89”); and, on the other hand, remaining unchanged at the rest of the addresses allocated for the graphic region R.

In addition, it is noted that, as the panning (e.g., the second panning with the offset vector (x2, y2)) causes the region R to change from a first content (e.g., C1) to a second content (e.g., C2), the first content may include a first portion (e.g., texts “33”) not included in the second content, the second content may include a second portion (e.g., text “B9”) not included in the first content, and the address translation in step 204 may be arranged to enable addresses for the second portion to be translated to addresses storing the first portion (e.g., enable the addresses for the text “B9” to be translated to the addresses originally storing the text “33” in the buffer content Bb1), so as to minimize effort for updating the buffer region M. Furthermore, though components x1, y1, x2 and y2 of the offset vectors (x1, y1) and (x2, y2) are nonzero in the example of FIGS. 4a and 4b, one or more of the components x1, y1, x2 and y2 of the offset vectors (x1, y1) and (x2, y2) may be zero in different examples. In other words, an embodiment involving panning along a combination of a horizontal direction and a vertical direction may generally cover embodiment(s) involving vertical panning of zero horizontal offset, and/or embodiment(s) involving horizontal panning of zero vertical offset.

To sum up, the invention may reduce resource demands of rendering of panning by translating addresses requested by the producer and/or the consumer. The address translation may be performed by the address translator, and be unaware to the producer and/or the consumer. For example, as shown in FIGS. 4a and 4b, the producer 102 and/or the consumer 104 may operate as if a content of the buffer region M is the content bb2 (FIG. 4a), while the address translation may actually cause the content of the buffer region M to be the content Bb2 (FIG. 4b), and hence lower resources demands of rendering. Designs, implementations and operations of the producer and/or the consumer may therefore remain unchanged, so as to minimize costs of implementing the address translation. In an embodiment, the address translator may be a hardware to satisfy high-speed demands of high-resolution graphic interface. In another embodiment, the address translator may be a software, firmware, hardware or a combination thereof.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for improving rendering of a graphic interface, comprising:
in response to a panning request in at least a region of the graphic interface, obtaining an offset vector; and
in response to an address for accessing a buffer for the region, performing an address translation by translating the address to a translated address according to the offset vector.

2. The method of claim 1, wherein the offset vector is provided by a producer of the graphic interface according to the panning request.

3. The method of claim 1, wherein the address translation is performed when a producer of the graphic interface requests to write an address of the buffer.

4. The method of claim 1, wherein the address translation is performed when a consumer of the graphic interface requests to read an address of the buffer.

5. The method of claim 1, wherein the panning request causes the region to change from a first content to a second content, and the address translation is arranged to enable an address for a second pixel of the second content to be translated to an address storing a first pixel of the first content; and
wherein a position of the first pixel is separated from a position of the second pixel by an opposite vector of the offset vector.

6. The method of claim 1, wherein the panning request causes the region to change from a first content to a second content, and the address translation is arranged to enable an address for a pixel of the first content and an address for the same pixel of the second content to be respectively translated to two different addresses.

7. The method of claim 1, wherein the panning request is along a direction aligning a boundary of the region, and causes the region to change from a first content to a second content; the address translation causes an address for a corner pixel of the first content to be translated to a first address, and causes an address for said corner pixel of the second content to be translated to a second address; and the method further comprises:
within addresses of the buffer allocated for the region, updating the buffer at addresses extending from the first address until the second address along an opposite of the direction, and extending across along a second direction perpendicular to the direction; and
remaining unchanged at a number of the rest of the addresses allocated for the region.

8. The method of claim 1, wherein the panning request is along a combination of a horizontal direction and a vertical direction, and causes the region to change from a first content to a second content; the address translation causes an address for a corner pixel of the first content to be translated to a first address, and causes an address for said corner pixel of the second content to be translated to a second address; and the method further comprises:
within addresses of the buffer allocated for the region, updating the buffer at addresses extending from the first address until the second address along an opposite of the vertical direction and horizontally extending across; and, updating the buffer at addresses extending from the first address until the second address along an opposite of the horizontal direction and vertically extending across; and
remaining the content of the buffer unchanged at a number of the rest of the addresses allocated for the region.

9. The method of claim 1, wherein the address translation is performed by a hardware address translator.

10. The method of claim 1, wherein the offset vector is obtained via an API (application programming interface) which is called by a producer of the graphic interface.

11. The method of claim 1, wherein:
the panning request causes the region to change from a first content to a second content;
the first content includes a first portion not included in the second content, and the second content includes a second portion not included in the first content; and
the address translation is arranged to enable addresses for the second portion to be translated to addresses storing the first portion.

12. A processor for improving rendering of a graphic interface, comprising:
an access circuit for accessing a buffer; and
an address translator coupled to the access circuit, for:
in response to a panning request in at least a region of the graphic interface, obtaining an offset vector; and
in response to an address of the buffer for the region, performing an address translation by translating the address to a translated address according to the offset vector, and then enabling the access circuit to access the translated address of the buffer instead.

13. The processor of claim 12, wherein the offset vector is provided by a producer of the graphic interface according to the panning request.

14. The processor of claim 12, wherein the address translation is performed when a producer of the graphic interface requests to write an address of the buffer.

15. The processor of claim 12, wherein the address translation is performed when a consumer of the graphic interface requests to read an address of the buffer.

16. The processor of claim 12, wherein the panning request causes the region to change from a first content to a second content, and the address translation is arranged to enable an address for a second pixel of the second content to be translated to an address storing a first pixel of the first content; and
wherein a position of the first pixel is separated from a position of the second pixel by an opposite vector of the offset vector.

17. The processor of claim 12, wherein the panning request causes the region to change from a first content to a second content, and the address translation is arranged to enable an address for a pixel of the first content and an address for the same pixel of the second content to be respectively translated to two different addresses.

18. The processor of claim 12, wherein the panning request is along a direction aligning a boundary of the region, and causes the region to change from a first content to a second content; the address translation causes an address for a corner pixel of the first content to be translated to a first address, and causes an address for said corner pixel of the second content to be translated to a second address; and, the address translator further enables a content of the buffer to be formed by:
within addresses of the buffer allocated for the region, updating at addresses extending from the first address until the second address along an opposite of the direction, and extending across along a second direction perpendicular to the direction; and
remaining unchanged at a number of the rest of the addresses allocated for the region.

19. The processor of claim 12, wherein the panning request is along a combination of a horizontal direction and a vertical direction, and causes the region to change from a first content to a second content; the address translation causes an address for a corner pixel of the first content to be translated to a first address, and causes an address for said corner pixel of the second content to be translated to a second address; and, the address translator further enables a content of the buffer to be formed by:
within addresses of the buffer allocated for the region, updating at addresses extending from the first address until the second address along an opposite of the vertical direction and horizontally extending across; and, updating at addresses extending from the first address until the second address along an opposite of the horizontal direction and vertically extending across; and
remaining unchanged at a number of the rest of the addresses allocated for the region.

20. The processor of claim 12, wherein:
the panning request causes the region to change from a first content to a second content;
the first content includes a first portion not included in the second content, and the second content includes a second portion not included in the first content; and
the address translation is arranged to enable addresses for the second portion to be translated to addresses storing the first portion.
